(19) United States
(12) Patent Application Publication
(10) Pub. No.: US 2012/0020374 A1
(43) Pub. Date: Jan. 26, 2012

(54) Method and System for Merging Network Stacks

(76) Inventors: Kenneth JONSSON, Sollentuna (SE); Markus Carlstedt, Uppsala (SE); Rikard Mendel, Solna (SE)

(21) Appl. No.: 12/843,217

(22) Filed: Jul. 26, 2010

(51) Int. Cl. H04L 12/56

(52) U.S. Cl. 370/419

(57) ABSTRACT

A system includes a network interface and a plurality of processing cores. The network interface includes a plurality of ports. A first one of the cores processes tasks relating to a native network stack owning a first one of the ports. A second one of the cores processes tasks relating to an accelerated network stack owning a second one of the ports. The accelerated network stack receives a packet using the second port, determines an acceleration status of the packet, sends the packet to the native network stack if the acceleration status is not accelerated, and processes the packet if the acceleration status is accelerated.

### BACKGROUND

Modern CPUs incorporate increasing numbers of processing cores, and efficient utilization of these cores is a challenging task. Synchronization techniques, such as resource locking, may severely decrease throughput and the ability to scale with the number of cores.

### SUMMARY OF THE INVENTION

A system including a network interface and a plurality of processing cores. The network interface comprises a plurality of ports. A first one of the cores processes tasks relating to a native network stack owning a first one of the ports. A second one of the cores processes tasks relating to an accelerated network stack owning a second one of the ports. The accelerated network stack receives a packet using the second port, determines an acceleration status of the packet, sends the packet to the native network stack if the acceleration status is not accelerated, and processes the packet if the acceleration status is accelerated.

A method includes receiving, at an accelerated network stack corresponding to a first processor, a packet from a packet network. The method also includes determining an acceleration status of the packet. The method also includes processing the packet using an application corresponding to the accelerated network stack, if the acceleration status is accelerated. The method also includes sending the packet to a native network stack corresponding to a second processor, if the acceleration status is not accelerated.

A computer readable storage medium stores a set of instructions executable by a processor. The set of instructions is operable to receive, at an accelerated network stack corresponding to a first processor, a packet from a packet network. The set of instructions is further operable to determine an acceleration status of the packet. The set of instructions is further operable to process the packet using an application corresponding to the accelerated network stack, if the acceleration status is accelerated. The set of instructions is further operable to send the packet to a native network stack corresponding to a second processor, if the acceleration status is not accelerated.

### BRIEF DESCRIPTION OF THE DRAWINGS

FIG. 1 shows an exemplary system including a plurality of network stacks.

FIG. 2 shows an exemplary method for processing a packet received by an accelerated computing environment of one of the network stacks of FIG. 1.

### DETAILED DESCRIPTION

The exemplary embodiments of the present invention may be further understood with reference to the following description and the appended drawings, wherein like elements are referred to with the same reference numerals. The exemplary embodiments describe methods and systems for making multiple network stacks act as a single node.

Modern CPUs may incorporate multiple processing cores; efficient use of these cores may be a challenging task. This is particularly true in networking applications, as the number of processing cycles spent on each individual packet may be very small. Any kind of synchronization (e.g., locking of a resource for the exclusive use for an individual task or class of tasks) that is utilized may therefore severely decrease a system's overall throughput, and, in many cases, may also reduce the ability to scale performance with the number of cores.

Creating a fully featured network stack with traditional Berkeley Software Distribution (“BSD”) socket application programming interface (“API”) that uses no limited locking, which is desirable for the reasons described above, is difficult because very few CPU cycles are spent on each packet, and packets that belong to the same socket and/or stream are interdependent. These inter-packet/inter-stream dependencies may manifest themselves as shared objects and structures in most network stack implementations. The exemplary embodiments may enable a system to use a fully-featured stack, such as a Linux native stack, together with one or more small, feature-limited, scalable (across multiple cores) network stacks, which will be referred to herein as network acceleration elements (“NAE”).

In systems implementing the exemplary embodiments, most network applications may run on top of the fully-featured stack, using standard BSD socket API. However, performance-critical applications may run on an NAE. An NAE environment may provide a non-standard socket API (e.g., rather than using the standard “recv( )” function to copy received data from a kernel buffer into a buffer provided by a caller, a non-standard socket API could deliver the kernel buffer directly to an application by invoking an asynchronous callback routine), allowing for a run-to-completion model even for applications running on top of transport layer protocols such as transmission control protocol (“TCP”), user datagram protocol (“UDP”), and stream control transmission protocol (“SCTP”). For these performance-critical applications, a run-to-completion model may yield higher throughput than a traditional BSD socket model. Further, as will be described in detail herein, a system operating in accordance with the exemplary embodiments and executing multiple stacks may appear as a single network node to an external observer.

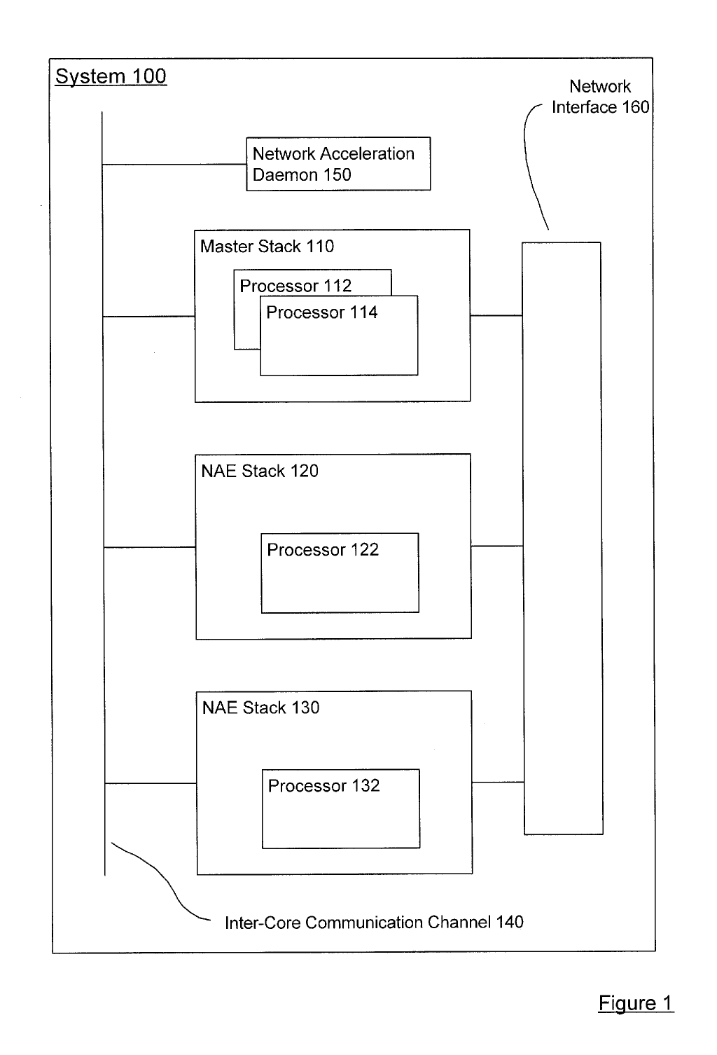

FIG. 1 illustrates a schematic view of a system 100 operating in accordance with an exemplary embodiment. As described above, the system 100 may include a plurality of network stacks. The first may be a fully-featured native network stack referred to herein as a master stack 110 running a conventional symmetric multiprocessing operating system. The master stack 110 may run on one or more processing cores; in the exemplary system 100, the master stack 110 runs on two processing cores 112 and 114. The system 100 may also include one or more NAE stacks as described above. In the embodiment of FIG. 1, the system 100 includes two NAE stacks 120 and 130, but other embodiments may include varying numbers of NAE environments. The NAE stacks 120 and 130 run on processing cores 122 and 132, respectively, which are dedicated to accelerating networking tasks, and may behave as described herein. The master stack 110 and the NAE stacks may share a network interface.

The system 100 also includes an inter-core communication channel 140, which provides for communication between the master stack 110 and the NAE stacks 120 and 130. Additionally, the system 100 may include a network acceleration daemon (“NAD”) 150, which is capable of communicating with the master stack 110 and the NAE stacks 120 and 130 (e.g., as illustrated in FIG. 1, via the inter-core communication channel 140), and which insures that the state of the master stack 110 is mirrored in the NAE stacks 120 and 130, as will be described below. The NAD 150 may propagate, to the NAE stacks 120 and 130, any change to the master stack 110; the NAD 150 may subscribe to events generated by the master stack 110 when its state changes, and may then propagate these changes to the NAE stacks 120 and 130 via the inter-core communication channel 140. Such changes may include, for example, addition or removal of an IP address or any modification to the forward information base (“FIB”) or neighbor cache. This may insure that the NAE stacks 120 and 130 may make the same forwarding decisions as the master stack 110, may have the same neighbor information, may treat the same set of IP addresses as local, etc.

Network ports between the exemplary system 100 and external environments may be divided into two classes. Ports receiving packets for which network acceleration should be may be owned by one of the NAE stacks 120 and 130. Each port owned by one of the NAE stacks 120 and 130 may be visible to the master stack 110 as a virtual network interface called an “ifproxy”. An ifproxy interface is a proxy for a physical network port (e.g., an Ethernet port) and may behave like a physical Ethernet device; anything written thereto is sent over the inter-core communication channel 140 to the NAE stack (e.g., NAE stack 120) that will write the frame to the actual hardware. There may be one ifproxy interface corresponding to each physical network port controlled by one of the NAE stacks. Packets that have been received by an NAE stack, but which cannot be handled by the NAE stack, may be delivered to the master stack 110 via the ifproxy interface; the master stack 110 interacts with physical interfaces controlled by the NAE stacks only via the ifproxy interface.

Ports for which network acceleration should not be provided may be owned by the master stack 110. The master stack 110 may provide network drivers for the network interface card (“NIC”) for such ports. Ports used for administration may be configured in this manner, as additional overhead may be incurred in using the ifproxy interface for traffic that is destined for the master stack 110.

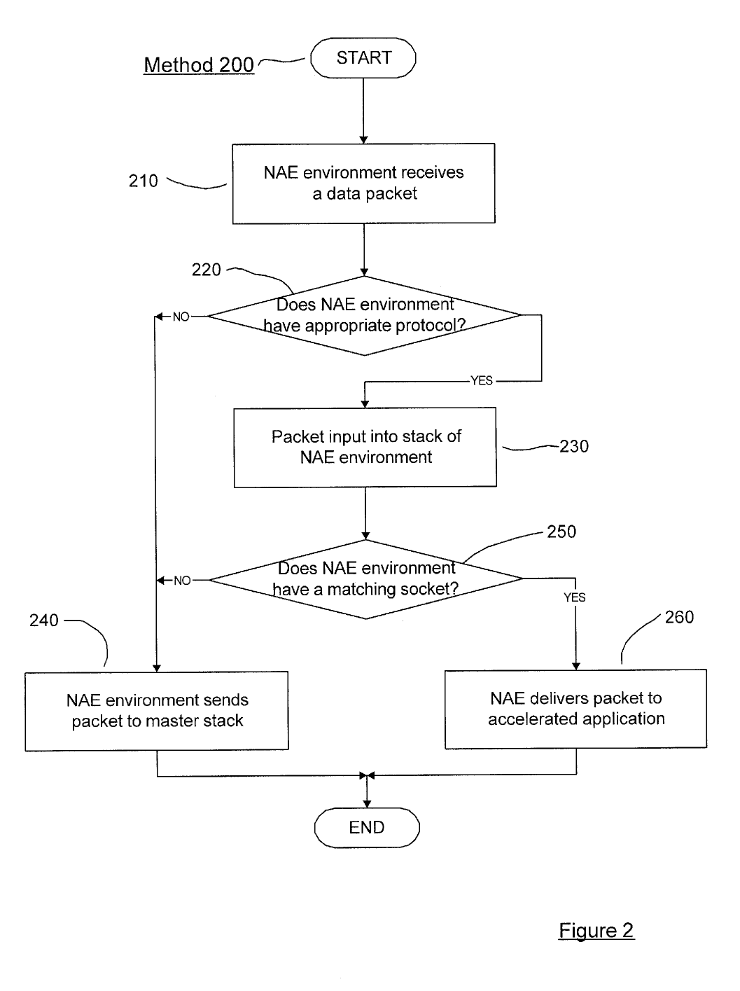

FIG. 2 illustrates an exemplary method 200 by which the exemplary system 100 may process a packet received on a port corresponding to one of the NAE stacks 120 and 130. The exemplary method 200 will be described with reference to the NAE stack 120, though the NAE stack 130 and further NAE stacks may behave in substantially the same manner. In step 210, a packet is received at the link layer (e.g., layer 2) of the NAE stack 120 from an accelerated port. In step 220, the NAE stack 120 determines whether it has a protocol implemented that is appropriate for the packet received in step 210. If an appropriate protocol has been implemented, then in step 230 the packet is input into the network layer and transport layer (e.g., layers 3 and 4) of the stack of the NAE environment 120. Conversely, if the NAE stack 120 has not implemented an appropriate protocol, then in step 240 the packet is passed to the master stack 110 via the inter-core communication channel 140.

After step 230, in which the packet is input into the stack of the NAE stack 120, in step 250 the NAE stack 120 determines whether it has a matching socket corresponding to the packet. If so, then in step 260 the NAE stack 120 delivers the packet to the appropriate application using the matching socket. If not, then the method 200 proceeds to step 240 as described above, and the packet is delivered to the master stack 110. After steps 240 and 260, the method 200 terminates.

Through the application of the exemplary method 200, the NAE stacks 120 and 130 may process any received packets for which they have an appropriate implementation, and in which an NAE application is interested. Other packets will be delivered to the master stack 110 through the ifproxy interface, as described above. In the exemplary embodiments, the NAE stacks 120 and 130 do not provide implementations for address resolution protocol (“ARP”), neighbor discovery protocol (“NDP”), and Internet control message protocol (“ICMP”), as packets for these protocols may change the FIB or the neighbor cache. Rather, such packets may be delivered to the master stack 110, so that any changes to the FIB or to the neighbor cache may be propagated to the NAE stacks 120 and 130 by the NAD 150. The NAE stacks 120 and 130 may not generate packets such as ICMP port unreachable and TCP reset; such decisions may be made by the master stack 110.

The exemplary embodiments may enable system administrators to use standard socket APIs for applications that are not performance-critical, while using NAE stacks as described above to provide accelerated performance for applications that such administrators may deem to be critical. Applications that may be appropriate for such handling include layer 4 bridges/proxies between 3G/4G telephone networks and the Internet. For such applications, the run-to-completion API described above may provide increased per-CPU performance and increased scalability across multiple CPU cores. Because the two types of API are combined in a single exemplary system, an incremental migration path may be provided from standard socket applications to special-purpose applications that are capable of making efficient use of multi-core CPUs.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A system, comprising:
a network interface comprising a plurality of ports;
a plurality of processing cores, a first one of the cores processing tasks relating to a native network stack owning a first one of the ports, a second one of the cores processing tasks relating to an accelerated network stack owning a second one of the ports,
wherein the accelerated network stack receives a packet using the second port, determines an acceleration status of the packet, sends the packet to the native network stack if the acceleration status is not accelerated, and processes the packet if the acceleration status is accelerated.

2. The system of claim 1, wherein the native network stack is a Linux native stack.

3. The system of claim 1, wherein the accelerated network stack determines the acceleration status of the packet by determining whether it has implemented a protocol relating to the packet.

4. The system of claim 1, wherein the accelerated network stack determines the acceleration status of the packet by determining whether it has a socket relating to the packet.

5. The system of claim 1, wherein the accelerated network stack sends the packet to the native stack using an intercore communication channel connecting the first core and the second core.

6. The system of claim 1, further comprising:
a network acceleration daemon propagating, to the accelerated network stack, a change to a network status of the master stack.

7. The system of claim 6, wherein the network status is one of an IP address, a forward information base, and a neighbor cache.

8. A method, comprising:
receiving, at an accelerated network stack corresponding to a first processor, a packet from a packet network;
determining an acceleration status of the packet;
processing the packet using an application corresponding to the accelerated network stack, if the acceleration status is accelerated; and
sending the packet to a native network stack corresponding to a second processor, if the acceleration status is not accelerated.

9. The method of claim 8, wherein the native network stack is a Linux native stack.

10. The method of claim 8, wherein the accelerated network stack determines the acceleration status of the packet by determining whether it has implemented a protocol relating to the packet.

11. The method of claim 8, wherein the accelerated network stack determines the acceleration status of the packet by determining whether it has a socket relating to the packet.

12. The method of claim 8, wherein the accelerated network stack sends the packet to the native stack using an intercore communication channel connecting the first processor and the second processor.

13. The method of claim 8, further comprising:
propagating, by a network acceleration daemon, a change to a network status of the master stack to the accelerated network stack.

14. The method of claim 13, wherein the network status is one of an IP address, a forward information base, and a neighbor cache.

15. A computer readable storage medium storing a set of instructions executable by a processor, the set of instructions being operable to:
receive, at an accelerated network stack corresponding to a first processor, a packet from a packet network;
determine an acceleration status of the packet;
process the packet using an application corresponding to the accelerated network stack, if the acceleration status is accelerated; and
send the packet to a native network stack corresponding to a second processor, if the acceleration status is not accelerated.

16. The computer readable storage medium of claim 15, wherein the native network stack is a Linux native stack.

17. The computer readable storage medium of claim 15, wherein the accelerated network stack determines the acceleration status of the packet by determining whether it has implemented a protocol relating to the packet.

18. The computer readable storage medium of claim 15, wherein the accelerated network stack determines the acceleration status of the packet by determining whether it has a socket relating to the packet.

19. The computer readable storage medium of claim 15, wherein the accelerated network stack sends the packet to the native stack using an intercore communication channel connecting the first processor and the second processor.

20. The computer readable storage medium of claim 15, wherein the set of instructions is further operable to:
propagate, by a network acceleration daemon, a change to a network status of the master stack to the accelerated network stack.

21. The computer readable storage medium of claim 20, wherein the network status is one of an IP address, a forward information base, and a neighbor cache.
